(19) United States
(12) Patent Application Publication
(10) Pub. No.: US 2006/0165988 A1
(43) Pub. Date: Jul. 27, 2006

(54) Carbon nanoparticles and composite particles and process of manufacture

(76) Inventors: Yet-Ming Chiang, Framingham, MA (US); John B. Vander Sande, Newbury, MA (US)

Correspondence Address: STEPTOE & JOHNSON LLP, 1330 CONNECTICUT AVENUE, N.W., WASHINGTON, DC, 20036, US

(21) Appl. No.: 10/510,482

(22) PCT Filed: Apr. 9, 2003
(86) PCT No.: PCT/US03/10822

§ 371 Date: Apr. 19, 2005

Related U.S. Application Data
(60) Provisional application No. 60/370,732, filed on Apr. 9, 2002.

(51) Int. Cl. B32B 9/02

(52) U.S. Cl. 428/402.2

(57) ABSTRACT

Carbide powders can be partially or completely converted to substantially densely-packed carbon nanotubes by thermochemical treatment. When partially converted, the resulting materials can consist of a metal carbide core, such as silicon carbide, onto which a surface layer of fullerenic carbon, such as carbon nanotubes, has been grown.

### CLAIM OF PRIORITY

This application claims priority under 35 USC §119(e) to U.S. Patent Application Ser. No. 60/370,732, filed on Apr. 9, 2002, the entire contents of which are hereby incorporated by reference.

### FEDERALLY SPONSORED RESEARCH OR DEVELOPMENT

The U.S. Government may have certain rights in this invention pursuant to Grant No. N000014-98-1-0354 awarded by the Office of Naval Research.

### TECHNICAL FIELD

This invention relates to compositions including carbon nanoparticles and methods of preparing carbon nanoparticles.

### BACKGROUND

Carbon can adopt a fullerene-like structure, or fullerenic structure, such as in a C₆₀ or C₇₀ fullerene or a carbon nanotube. A carbon nanotube can have a helical tubular structure and can have a single wall or multiple substantially concentric walls. Carbon nanotubes can have diameters ranging between a few nanometers to a few hundred nanometers. Carbon nanotubes can be conductors or semiconductors. The unique structure of the nanotubes can provide good mechanical, electrical and chemical properties. The high aspect ratio of carbon nanotubes can provide high strengths, for example, a high specific modulus (Young's modulus ˜1 TPa) and tensile strength (˜60 GPa). The electrical and chemical properties of the nanotubes can be suitable for hydrogen and lithium storage for electrochemical energy sources such as fuel cells and lithium batteries. Previous methods of preparing carbon nanotubes include arc-discharge, chemical vapor deposition, and flame processes.

### SUMMARY

In one aspect, a composition includes a particle including a core and a shell, the core including a metal carbide and the shell including a carbon nanoparticle on at least a portion of a surface of the core. In another aspect, a composition includes a particle including substantially densely-packed carbon nanoparticles.

The shell can cover at least 50%, 65%, 80%, 90%, or 95% of the surface. The particle can include at least 2%, 5%, 10%, 15%, 25%, 50%, 75%, 90% or 95% by volume carbon. The shell can have an average thickness of at least 2.5, 5, 10, 25, 50 or 100 nm. The particle can have an average diameter of less than 100, 50, 20, 10, 5, 2.5, 1.0, 0.5, 0.25, or 0.1 micrometers.

The carbon nanoparticle is a fragment of elemental carbon having nanometer-scale dimensions. The carbon nanoparticle can be a single-walled carbon nanotube, a multi-walled carbon nanotube, or a nanofiber. The carbon nanoparticle can be chemically attached to the core of silicon carbide, for example, by at least one end of the nanotube or nanofiber. The carbon nanoparticle can include a carbon nanotube or carbon nanofiber being open at an end not attached to the core. The carbon nanoparticle can include fillerenic carbon. Fullerenic carbon is carbon containing five-membered rings. A carbon nanotube can be fullerenic carbon in the shape of a tube that may be open or closed on the ends, the diameter of the tube being measured in nanometers. A number of nanotubes can become associated in a nanofiber having a greater length than an individual nanotube.

The metal carbide can be silicon carbide. The carbon nanoparticle can include fullerenic carbon. The shell can cover at least 50% of a surface of the core. The particle can include at least 2% by volume carbon nanoparticles. The shell can have an average thickness of at least 2.5 nanometers. The particle can have an average diameter of less than 100 micrometers. The carbon nanoparticles can include a single-walled or multi-walled carbon nanotube or a nanofiber chemically attached to the core at at least one end. The carbon nanoparticles can include a carbon nanotube or carbon nanofiber open at an end. At least one end of the nanotube or nanofiber can be closed. At least one end of the nanotube or nanofiber can be open. The composition can include a coating of metal or metal oxide on the carbon nanoparticles.

A grinding or finishing product can include the particle. The product can be a grinding wheel, a cutting wheel, a coated abrasive or a suspension of abrasive particles in a liquid. A structurally reinforced composite can include the particle. An electrochemical storage medium can include the particle. A hydrogen storage medium can include the particle.

In another aspect, a composite abrasive particle can include a core and a shell, the core including a metal carbide and the shell including a carbon nanoparticle on at least a portion of a surface of the core. An abrasive particle can include substantially densely-packed carbon nanoparticles. The abrasive particle can have a coating of metal or metal oxide on the carbon nanoparticle.

In another aspect, a method of manufacturing an article including a carbon nanoparticle on a surface of the article includes heating an article including a metal carbide in a first atmosphere for a period of time to generate at least one carbon nanoparticle nucleus on the surface of the article, the first atmosphere being an oxidizing atmosphere relative to the metal carbide, and heating the article including nuclei of carbon nanoparticles in a second atmosphere to grow the carbon nanoparticles on the surface of the article. In another aspect, a method of manufacturing an article including carbon a nanoparticle on a surface of the article includes heating an article including a metal carbide in an oxygen-containing gas atmosphere at a temperature at which the metal carbide is in an active oxidation regime and carbon is in a graphite stability regime. The gas and temperature can be selected based on accepted thermochemical data. See E. A. Gulbransen and S. A. Jansson, Oxid Metals, 4[3], 181 (1972), which is incorporated by reference in its entirety. In another aspect, a method of manufacturing an article including a carbon nanoparticle on a surface of the article includes heating an article including a metal carbide in an inert gas atmosphere at a temperature between 1000° C. and 2000° C.

The atmosphere can includes CO or a mixture of CO and CO₂. The second atmosphere can include an inert gas. The inert gas can include a gas selected from the group of helium, hydrogen, argon, and a nitrogen-hydrogen mixture. The article including the metal carbide can be heated to nucleate the carbon nanoparticles prior to heating the article including the metal carbide in an inert gas atmosphere at a temperature between 1000° C. and 2000° C. The carbon nanoparticles can include fullerenic carbon. The metal carbide can be silicon carbide. The pressure can be greater than 10⁻³ Torr. The pressure can be greater than 10⁻² Torr. The temperature can be between 1200° C. and 2000° C.

In another aspect, a method of forming a composite includes dispersing carbon nanoparticles in a matrix including an oxide of a first metal, and contacting the matrix with a reducing agent to reduce the oxide of the first metal. The reducing agent can be a second metal. The first metal can be copper, iron, lead, nickel, cobalt, tin, zinc, sodium, chromium, manganese, tantalum, vanadium, or boron. The second metal can be silicon, titanium, aluminum, cerium, lithium, magnesium, calcium, lanthanum, beryllium, uranium, or thorium.

Previous methods of preparing carbon nanotubes such as arc-discharge, chemical vapor deposition, and flame processes result in highly dispersed fullerenes and carbon nanotubes of low packing density. This is a disadvantage for many applications where a high volume fraction of fullerenes in the final product is desired. Furthermore, fullerenes produced by arc-discharge or chemical vapor deposition are expensive materials currently selling for thousands of dollars per pound. In order to realize widespread application of carbon nanotubes, economical processes and starting materials are necessary. The method of manufacturing fullerenic carbon can be used to produce large volumes of relatively dense fullerenic carbon at a lower cost per unit weight than previous methods. The method can provide fullerenic carbon that is largely free of graphite or amorphous carbon.

The details of one or more embodiments are set forth in the accompanying drawings and the description below. Other features, objects, and advantages will be apparent from the description and drawings, and from the claims.

### DESCRIPTION OF DRAWINGS

FIG. 1 is an electron microscope image of a silicon carbide particle partially converted to carbon nanoparticles. The silicon carbide core is indicated.

FIG. 2 is an electron microscope image of a silicon carbide particle partially converted to carbon nanoparticles. The silicon carbide core is indicated.

FIG. 3 is an electron microscope image of a particle described in sample 6, Table 1, fully converted to carbon nanoparticles.

FIG. 4 is an electron microscope image of a particle described in sample 7, Table 1, fully converted to carbon nanoparticles.

FIGS. 5A and 5B are scanning electron microscope images of silicon carbide particles before (5A) and after (5B) conversion. The images are of material from sample 8, Table 1.

FIG. 6 is a graph depicting the charge-discharge characteristics of silicon carbide-derived carbon nanoparticles at 60 mA/g.

FIG. 7 is a graph depicting the capacity versus cycle number for silicon carbide-derived carbon nanoparticles at a current rate of 20 mA/g and 60 mA/g.

### DETAILED DESCRIPTION

Carbon nanoparticles and composite carbon nanoparticles can be used in applications including structurally reinforced composites in which particles are contained within a matrix, abrasives, polishing compounds, and electrochemical storage media and devices using such storage media. Carbon nanoparticles and composite carbon nanoparticles can be particles composed of an aggregate of single-walled or multiwalled carbon nanotubes that are compact or densely packed compared to previously produced forms of carbon nanotubes.

The composite particles can have an outer shell including a carbon nanoparticle which is attached to an underlying core of a material that is not a carbon nanoparticle. Such a composite fullerenic particle provides new functionality not achievable with dispersed fullerenes. The particles can have a wide range of fullerenic fraction ranging from a thin surface layer of fullerenic “caps” (e.g., a segment of a C₆₀ sphere) on an underlying substrate material, to a particle which can be entirely comprised of fullerenic material. The mean final particle size of the particles can be between 0.1 and 100 micrometers, such as between 0.1 and 20 micrometers or between 5 and 50 micrometers, wherein a carbon nanoparticle is on 50% to 100% of the external surface area. The volume fraction of the particles occupied by fullerenic carbon can be greater than 2%, corresponding to a thin surface shell, or greater than 10%, 20%, 30%, 40%, 50%, 60%, 70%, 80%, 90% or greater than 95%. The carbon nanoparticle can include segments of fullerenic molecules such as C₆₀ and C₇₀, single walled carbon nanotubes, or multiwalled carbon nanotubes.

Methods for growing the carbon nanoparticle from a core of a metal carbide can include a number of variations. Examples of metal carbides include chromium carbide, hafiiium carbide, iron carbide, niobium carbide, silicon carbide, titanium carbide, vanadium carbide, and zirconium carbide. The methods can produce a carbon nanoparticle that is largely free of graphite or amorphous carbon. In the first of these methods, carbon nanotubes are nucleated on the surface of a SiC particle. Carbon nanoparticle nuclei can be initial sites of fullerene formation on the surface of the particle. Nuclei can be nanotube “caps”, and can grow to form nanotubes. Nucleation can be achieved by providing a starting SiC that has a thin surface oxide layer, or by heating the SiC initially in an atmosphere containing sufficient oxygen to allow surface oxidation. This nucleation or seeding step can be followed by heating the material under thermochemical conditions that allow continued growth of the nucleated carbon nanotubes. The nucleation and growth processes can be carried out in a continuous manner (i.e., within the same heat treatment cycle), or the heat treatment can be interrupted after the nucleation step and a separate growth heat treatment conducted later. When a large fraction of carbon nanoparticles is desired or when large silicon carbide particles are employed, it can be especially advantageous to carry out the growth step under conditions that give maximum growth rates of the carbon nanotubes. One such growth condition includes heating the material in a carbon monoxide/carbon dioxide (CO/CO₂) gaseous atmosphere in which active oxidation of SiC, represented by the reaction
SiC(s)+½O₂(g)→SiO(g)+C(s)

is thermodynamically favored in the forward direction. Oxidation can be carried out in an atmosphere (as opposed to a sealed vessel) so that the SiO can volatilize, thus lowering the SiO activity in the vicinity of the sample. The oxygen necessary to sustain the reaction is provided by the CO/CO₂ gas mixture. The oxidation reaction can be carried out at temperatures and under gas atmospheres where the graphitic form of carbon is stable as a solid phase (the graphite stability regime). Maintaining conditions in the graphite stability regime ensures that the growing carbon nanotubes are not themselves oxidized to CO or CO₂. The rate of conversion of the silicon carbide to carbon nanotubes can be maximized by electing thermochemical conditions where the SiO vapor pressure is maximized and conducting the process in an open or convective gas atmosphere such that the transport of SiO gas away from the particles is improved (the SiC oxidation regime). Conditions can be selected such that graphite is in its stability regime and SiC in its oxidation regime simultaneously. The temperatures and gas mixtures necessary to accomplish these objectives are readily determined from available thermochemical data. See E. A. Gulbransen and S. A. Jansson, Oxid Metals, 4[3], 181 (1972).

A second method includes nucleation or growth processes in which the direct volatilization of Si as a vapor allows growth of the carbon nanotubes via the reaction
SiC(s)→Si(g)+C(s)

In this instance, no oxygen source is necessary. The gas atmosphere used can be at a reduced pressure, such as a pressure greater than 10⁻³ Torr, or can be an inert gas such as argon, helium, hydrogen, or nitrogen-hydrogen mixtures. A mixture of a reactive gas and an inert gas can also be used, and one or both of the two mechanisms of growth can be carried out in a given heat treatment.

Another method of fabricating the composite particles can include growing fullerenes from an external source of carbon on a particle of silicon carbide or a fullerenic particle derived from silicon carbide. The source of carbon can be a gas phase reactant as is used in the chemical vapor deposition or flame synthesis of fullerenes.

The carbon nanoparticle materials can be subsequently treated to improve their properties for specific applications. Such methods include chemical or thermochemical/oxidation treatments that open the ends of the carbon nanotubes, allowing better penetration by hydrogen or lithium, or coating the carbon nanotubes with another material to improve wetting or bonding. Another method of improving electrochemical storage capacity is the process of first coating or filling the carbon nanotubes with a metal oxide, then reducing the metal oxide chemically or thermochemically to its metal. The metal can then reversibly alloy with lithium or hydrogen without capacity loss. The volume expansion that occurs upon alloying is accommodated by shrinkage that occurred during the reduction step.

A powder can include particles having a surface including predominantly fullerenic “caps” or open tubes, formed by carrying out one of the above processes to produce fullerenes on a substrate, and subsequently removing or dissolving the substrate to leave behind the open fullerenes.

A manufacturing process for the carbon nanoparticle or composite particles can include a continuous conveyer system that carries the starting silicon carbide powder through a furnace or series of furnaces in which thermochemical conditions are controlled to effect nucleation and growth of carbon nanotubes. At the end of the conveyer system a continuous supply of carbon nanoparticle or composite powder is delivered. Alternatively, a fluidized-bed reactor can be used to continuously stir silicon carbide powder while heating under an atmosphere of one of the above-mentioned gases to maintain the desired thermochemical conditions. In this process, convection increases the carbon nanotube conversion rate and uniformity within the powder bed.

Silicon carbide powder can be partially or completely converted to substantially densely-packed carbon nanotubes by thermochemical treatment. Densely-packed nanotubes are denser than nanotubes produced by other methods. They can by denser measured by weight or by volume. When partially converted, the resulting materials consist of a silicon carbide core onto which a surface layer of carbon nanotubes has been grown. The carbon nanotubes can be grown so that they are substantially parallel and have their axes oriented outwards from the particle surface, with the interior end of the nanotubes bonded to the silicon carbide core. In addition, the nature of the carbon nanoparticle material and its orientation or texture can be varied should such variations prove important in enhancing properties and performance of the particle. The fraction of the particle that is silicon carbide and that is fullerenic can be controlled by the heat treatment atmosphere, time, and temperature. When fully converted, particles consisting of densely-packed carbon nanotubes can be obtained.

Abrasives and polishing compounds for grinding and finishing can include a carbon nanoparticle produced from silicon carbide that is partially or completely converted. Grinding and cutting wheels, coated abrasives, and suspensions in liquid media including the carbon nanoparticle or composites can be used for cutting or polishing. The carbon nanoparticle can be modified such that the ends of the nanotubes can be opened by chemical (e.g., acid) or thermochemical/oxidation treatments, or the carbon nanoparticle can be coated or infiltrated with a metal oxide or metal.

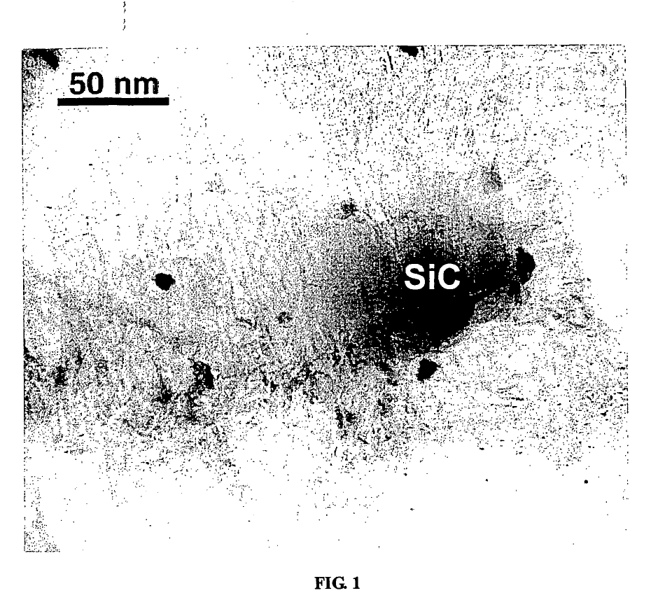

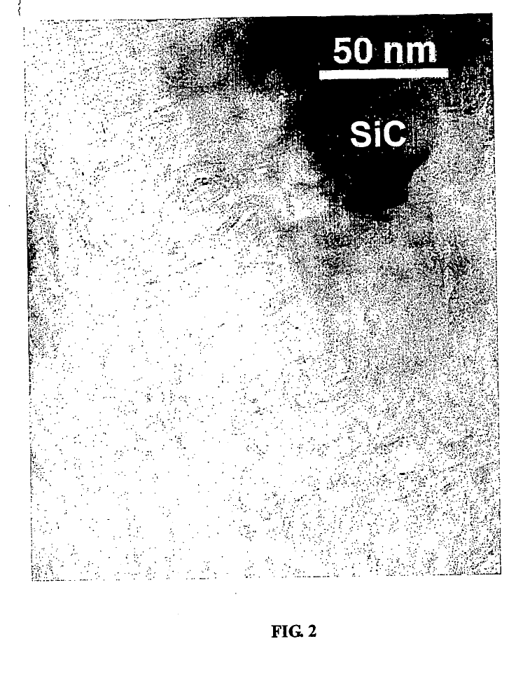

Reinforcing carbon nanoparticle-containing composites can be prepared using the materials. Carbon nanotubes have enormous tensile strength and elastic modulus, but being composed of closed graphene sheets, are known to chemically bond to only a limited number of materials. However, when a multiplicity of carbon nanotubes are grafted to an underlying silicon carbide particle, the resulting composite particle has a “brushy” exterior which is more easily functionalized or bonded to. See, for example, FIG. 1 or FIG. 2. The carbon nanoparticle or composite particles can be useful as reinforcing additives in a broad range of composite materials. Specific applications including use as reinforcements in filled polymers and rubber tires, in the latter case replacing some or all of the currently used carbon black fillers. Performance advantages of a fullerene-filled polymeric or elastomeric composite compared to one made with conventional fillers include higher strength, fracture toughness, elastic modulus, thermal conductivity, and wear resistance.

The materials can be used as reinforcements in metal-matrix or ceramic-matrix composites in which the superior mechanical properties of carbon nanotubes can be useful. Suitable dispersion and wetting of the carbon nanoparticle can be achieved by dispersion/wetting of carbon nanotubes using metal oxides formed from aqueous solutions (i.e., sol-gel approach) or reduction of the wetted metal oxide to its metal, allowing subsequent alloying with common structural metals, for example, aluminum, Several metal oxides that can wet carbon nanotubes can be produced from solution, including V₂O₃, PbOₓ, and BiOₓ. See, for example, T. W. Ebbesen, Physics Today, p. 26, Jun. 1996 and P. M. Ajayan et al., Nature 375:564 (1995) and 361:333 (1993), each of which is incorporated by reference in its entirety. Weak van der Waals forces causing a dense-packed array of carbon nanotubes to remain aggregated can be overcome by wetting and penetration by the metal oxide. The metal oxide coating can be selected to be one that is thermochemically reduced by a matrix alloy, such as aluminum. Upon reduction of the coating to its metal, alloying and penetration by the aluminum matrix is expected.

Other transition metal oxides can also wet the carbon nanoparticle. Metals can be selected based on the ease of reduction and the utility of the metal as an alloying additive. Metals with less negative free energy of oxidation, namely those towards the top of the Ellingham diagram, are of greatest interest. In particular, the oxides of Cu, Sn, Zn, Fe, Ni, Co, Pb and Ag can be suitable. Of these, the oxides of Cu, Sn, Zn, and Ag can be especially easy to reduce at low temperatures. The oxides of Cu and Zn are of particular interest since they are components of 6000 and 7000 series aluminum alloys, respectively.

Electrochemical energy storage can be accomplished using the materials. High electrochemical storage capacity for lithium and hydrogen on a weight basis (gravimetric capacity) has been reported for various carbon nanotubes and carbon nanofibers. See, for example, C. Liu et al., Science, 286:1127 (1999), M. Dresselhaus et al., MRS Bulletin, p. 45, November 1999, D. Frackowiak et al., Carbon, 37:61-69 (1999), G. T. Wu et al., J. Electrochem. Soc., 146(5):1696 (1999), B. Gao et al., Phys. Lett., 307:153 (1999), and A. Chambers et al., J. Phys. Chem. B, 102, 4253 (1998), each of which is incorporated by reference in its entirety. However, while the specific capacity of carbon nanotubes is high, the volumetric capacity is low in comparison with metal hydrides used for fuel cells and nickel-metal-hydride rechargeable batteries, or denser forms of carbons used for anodes in lithium ion batteries. In real devices, volumetric capacity can be as or more important than specific capacity. Carbon nanotubes can have poor volumetric capacity because they are produced in loose form, and resist deformation upon compaction due to their exceptionally high elastic modulus (˜1 TPa). A dense-packed form of carbon nanoparticles that can be produced in sufficiently large quantities can take practical advantage of the high specific capacity.

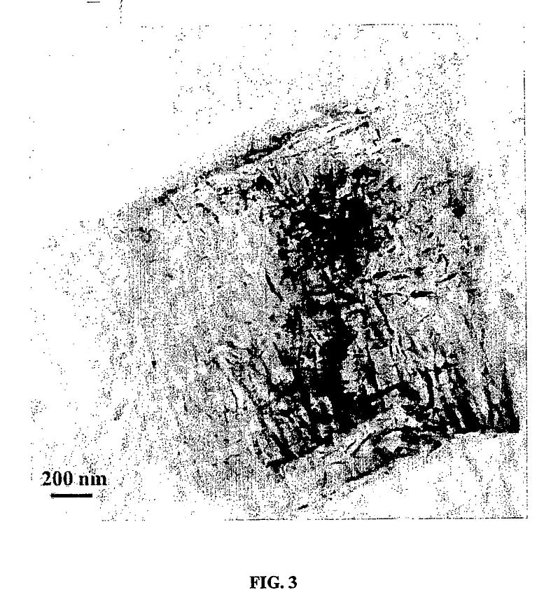

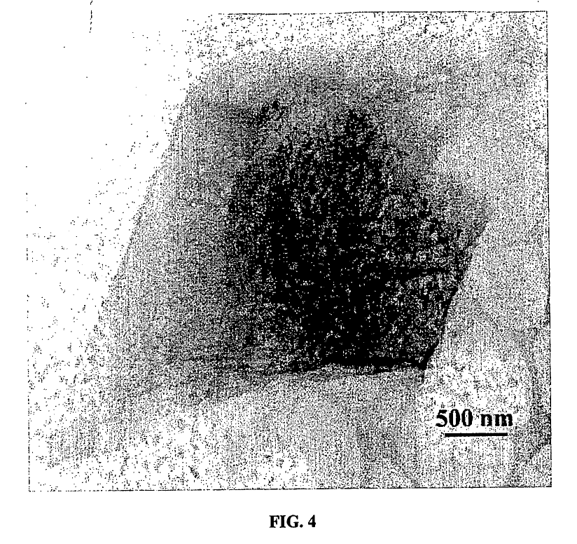

The examples contained herein show that silicon carbide powder with a particle size on the order of one micrometer can be completely converted to a substantially dense array of fullerenic carbon nanotubes. See FIGS. 3 and 4, and Table 1. Because the particles are on average more than 50% converted to carbon nanotubes, and the particles themselves can be packed to a volumetric density exceeding 50%, this material provides a carbon nanoparticle of high bulk packing density. Thus, unlike previous carbon nanoparticle materials with very low packing density, these new materials have greater utility as lithium ion, proton, or hydrogen gas storage materials due to the high volumetric density of the carbon nanoparticle. Gas storage in fullerene-based materials is described in, for example, U.S. Pat. No. 6,113,673, which is incorporated by reference in its entirety. A higher volumetric packing density allows a higher volumetric energy density for a given material. See FIGS. 1 and 2.

Electrochemical storage devices utilizing this novel material can include but are not limited to lithium batteries, metal hydride batteries, hydrogen storage materials, and fuel cells utilizing such hydrogen storage materials.

Abrasives and polishing compounds can be prepared using the materials. There are numerous potential advantages to including a carbon nanoparticle in abrasives. The composite nanostructure of a silicon carbide particle with an outer shell including a “brushy” array of a carbon nanoparticle allows improved bonding to matrix or adhesive materials that hold the abrasive particles. See, for example, FIG. 1 or FIG. 2. These matrix materials can be polymeric or metallic in nature, and the resulting composite can be a cutting or grinding wheel or a coated abrasive. Composites used in grinding applications are described in, for instance, U.S. Pat. No. 5,588,975, which is incorporated by reference in its entirety. Improved bonding of the abrasive to the matrix can improve the lifetime and cutting efficiency of the abrasive product. The carbon nanoparticle can be mechanically extremely strong and stiff, and is chemically and thermally quite stable. The carbon nanoparticle can also have at least one very well-defined dimension; in the case of the present process, multiwalled nanotubes of 2-10 nm diameter can be obtained. Compared to abrasives in which a distribution of particle sizes contact the work piece, abrasives including a carbon nanoparticle of well-defined and highly uniform dimensions can provide improved surface finishes. A composite particle of carbon nanoparticles grafted to an underlying silicon carbide particle can be very wear-resistant and durable. The overall particle size of the carbon nanoparticle or carbon nanoparticle-terminated abrasive particle is readily controlled, as it can be determined by the size of the starting SiC particle. Compared to other forms of carbon nanoparticles such as those made by arc discharge or laser ablation or chemical vapor deposition, the composite is much cheaper and has a higher packing density. It is more easily handled, and can be incorporated into grinding and finishing products at a higher volumetric density than is achievable with other forms of fullerenes.

When further modified, the abrasives acquire additional useful properties. As an example, the carbon nanoparticle structures can be coated, or the interior of the carbon nanotubes filled with a metal oxide such as SiO₂, Al₂O₃, or CeO₂ that exhibits chemical-mechanical polishing (CMP) activity. Combining the oxide with the carbon nanoparticle structure allows control of the active particle size, and improves the durability of the polishing compound. Electrochemical activity between the carbon, the oxide, or the work piece can also improve material removal rates or surface finish.

When coated with a metal or metal oxide, the bonding of the abrasive particle to polymeric or metallic matrix materials (e.g., for use as a cutting or grinding wheel) is further improved. In one variant of this concept, wetting of the particles by a metal is improved, allowing dispersion and good bonding of the abrasive to a metal matrix. A metal can be selected so that it is wet by the matrix metal. Similarly, the metal oxide can be selected to be one that is thermochemically reduced to its metal upon contacting the matrix metal. For example, a matrix metal with a more negative free energy of oxidation will reduce a coating metal oxide with less negative free energy of oxidation, allowing infiltration of the matrix metal between the carbon nanoparticles and resulting in good bonding. Aluminum, magnesium, and titanium are examples of metals with large negative free energies of oxidation, and which as a matrix material would reduce a coating that is an oxide of a metal such as copper, silver, tin, vanadium, iron, or zinc, which have less negative free energies of oxidation.

Abrasives and polishing compounds for grinding and finishing can include a carbon nanoparticle that has been partially or completely converted from silicon carbide. These materials can also be used in products such as grinding and cutting wheels, coated abrasives, and suspensions of the subject materials in liquid media used for cutting or polishing. Modified forms of carbon nanoparticles can be used in an abrasive or polishing application. Examples of modified carbon nanoparticle include nanotubes with ends that have been opened by chemical (e.g., acid) or thermochemical/oxidation treatments, or those that have been coated or filled with a metal oxide or other material.

The materials may also be used in microelectromechanical systems, or MEMS, applications. Regions including silicon carbide can be incorporated into silicon-based MEMS, and the silicon carbide regions can be subsequently converted to carbon nanoparticles. The regions including carbon nanoparticles can serve as a wear surface, a friction control surface, or an adhesion control surface in MEMS devices.

The following examples relate to the manufacture and use of carbon nanoparticles and composite particles.

### EXAMPLE 1

1.696 g of a Norton Company Crystolon™ SiC powder with a specific surface area of 15 m²/g was weighed into a high purity graphite crucible and placed in an Astro Industries, Inc. (Santa Barbara, Calif.) graphite resistance-heated high temperature furnace. The furnace was pumped down to primary vacuum using a rotary mechanical pump, and heated to 1700° C. and held at that temperature for 4 hours. Upon cooling, a blackish powder was observed on the surface of the sample whereas the powder was beige before heat treatment. The weight loss of the powder was measured to be 5%, indicating partial conversion of the SiC to carbon overall. (Full conversion has an ideal weight loss of 70%). The black surface powder was removed and studied by high resolution electron microscopy (HREM). An example of a micrograph depicting carbon nanotubes on a surface of a silicon carbide particle is shown in FIG. 1.

### EXAMPLE 2

0.304 g of a Norton Company Crystolon™ SiC powder with a specific surface area of 15 m²/g was spread on disc of high purity graphite crucible and placed in an Astro Industries, Inc. (Santa Barbara, Calif.) graphite resistance-heated high temperature furnace. The furnace was pumped down to primary vacuum using a rotary mechanical pump, and heated from 1000° C. to 1700° C. in about 1.5 hours, then held at 1690-1700° C. for 11 hours. Upon cooling, a black powder was observed on the surface of the sample whereas the powder was beige before heat treatment. Beige powder was observed underneath the black powder after the heat treatment as well. The weight loss of the powder was measured to be 45.7%, indicating partial conversion of the SiC to carbon overall. (Full conversion has an ideal weight loss of 70%). The black surface powder was removed and studied further. X-ray diffraction of this material showed sharp diffraction peaks for 6H-SiC, along with a broad peak at ˜36.3° where graphite has its strongest peak. The breadth of this peak was consistent with the presence of fullerenic carbon.

High resolution electron microscopy (HREM) was performed on this sample. An exemplary particle was ˜0.7 micrometer in breadth and ˜2.5 micrometer in length and consisted almost entirely of fullerenic carbon in the form of multiwalled nanotubes. The corresponding electron diffraction pattern shows that some crystallographic texture of the nanotubes exists within the particle. Higher magnification images showed arrays of carbon nanotubes in the sample. This example shows that particles of a silicon carbide powder can be completely converted to flilerenic particles through thermochemical treatment. These results demonstrate that volumetrically dense, bulk carbon nanotubes can be produced.

### EXAMPLE 3

0.127 g of a Norton Company Crystolon™ SiC powder with a specific surface area of 15 m²/g was spread on disc of high purity graphite crucible and placed in an Astro Industries, Inc. (Santa Barbara, Calif.) graphite resistance-heated high temperature furnace. The furnace was pumped down to primary vacuum using a rotary mechanical pump, and heated from 1000° C. to 1500° C. in about 0.5 hour, then held at 1500° C. for 14 hours. Upon cooling, a black powder was observed whereas the powder was beige before heat treatment. The weight loss of the powder was measured to be 13.4%, indicating less conversion of the SiC to carbon than in Example 2. Representative particles of about 0.1 to about 0.2 micrometer in diameter, respectively, showed that the entirety of the surface of the particle has been converted to carbon nanotubes, leaving in each instance a core of unconverted silicon carbide. The diameter of the carbon nanotubes ranged from 2-10 nm. This example shows that composite particles consisting of a fullerenic surface and silicon carbide core can be prepared by the thermochemical treatment of silicon carbide particles. A representative electron micrograph is shown in FIG. 2.

### EXAMPLE 4

0.084 g of a Norton Company Crystolon™ SiC powder with a specific surface area of 15 m²/g was spread on disc of high purity graphite crucible and placed in an Astro Industries, Inc. (Santa Barbara, Calif.) graphite resistance-heated high temperature furnace. The furnace was pumped down to primary vacuum using a rotary mechanical pump, and heated from 1000° C. to 1700° C. in about 0.5 hour, then held at 1700° C. for 24 hours. The powder was found to have lost 63.8% weight, which indicated that it was 91% converted to carbon. X-ray diffraction of this material showed that the broad peak at 26.3° to be of much greater intensity relative to the diffraction peaks for 6H-SiC compared to those observed in Example 3, confirming the nearly complete conversion of this SiC powder to carbon nanotubes.

### EXAMPLE 5

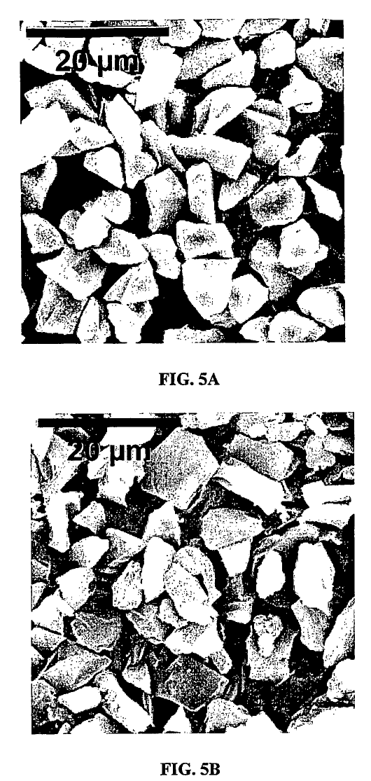

Following the heat treatment process described in Examples 1-4, several abrasive grade silicon carbide powders, as listed in Table 1, were heat treated at various temperatures and for various periods of time. The silicon carbide powders range in grit size from 600 grit to 1200 grit, and have median particle sized d₅₀ ranging from 2.5 micrometers to 10.1 micrometers. It was possible to heat treat these powders according to the methods described here, including the largest particle size materials, to obtain partial or complete conversion. FIG. 3 and FIG. 4 show transmission electron microscope images of single particles described in Table 1, samples 6 and 7, respectively. The entirety of the particle can be converted by the heat treatment to carbon nanoparticles. In FIG. 5, SEM images of the powder of sample 8 in Table 1 are shown before and after conversion. The external morphology of the particles remains essentially unchanged through the conversion process.

TABLE 1

| | SiC powder | Processing | Starting | Final | Weight | |
|---|---|---|---|---|---|---|
| | grit size | temp. (° C.), | weight | weight | loss | |
| Sample | (d₅₀) | time | (g) | (g) | (%) | Comments ^{†} |
| 6 | 1200 | 1700, 24 | 0.186 | 0.034 | 81.8 | complete |
| | (2.5 μm) | hours | | | | conversion |
| 7 | 600 | 1700, 24 | 0.200 | 0.215 | 78.5 | complete |
| | (10.1 μm) | hours | | | | conversion |
| 8 | 800 | 1700, 24 | 0.194 | 0.034 | 82.5 | complete |
| | (6.5 μm) | hours | | | | conversion |
| 9 | 1200 | 1700, 24 | 0.198 | 0.017 | 91.4 | complete |
| | (3 μm) | hours | | | | conversion |
| 10 | 1200 | 1700, 30 | 0.204 | 0.159 | 22.1 | partial |
| | (2.5 μm) | mins | | | | conversion |
| 11 | 1200 | 1300, 30 | 0.204 | 0.202 | 1.0 | slight |
| | (2.5 μm) | mins | | | | conversion |

^{†} Greater than 70% wt. loss indicates complete conversion.

### EXAMPLE 6

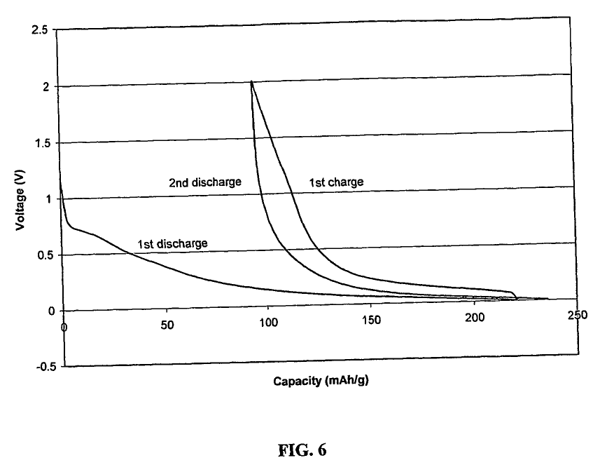

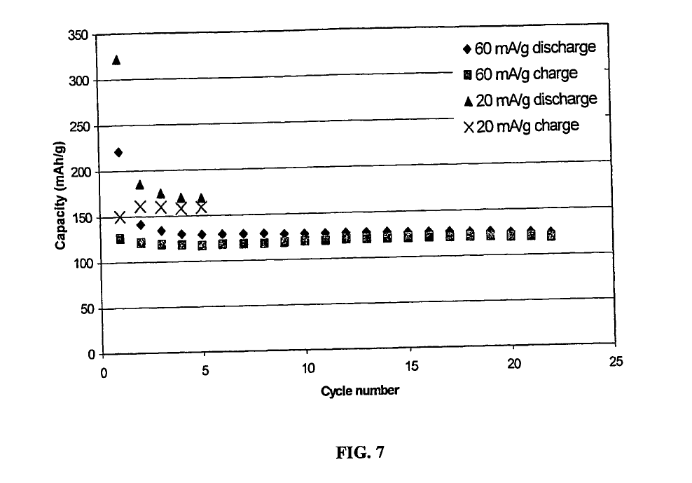

The material of Example 4 was found to readily intercalate lithium when tested in standard electrochemical cells. A portion of the material was mixed with polyvinylidene difluoride (PVDF) binder using y-butyrolactone as a solvent, dried and pressed into a thin ¼″ pellet and tested against a lithium metal counter electrode in a stainless-steel cell. A 1:1 by volume mixture of ethylene carbonate and diethylene carbonate electrolyte containing 1M LiPF₆ was used as the electrolyte, and a disk of Celgard™ as used as the separator. FIG. 6 shows the initial charge-discharge behavior of a cell cycled at a relatively high current rate of 60 mAh/g between 0.005 and 2 V. This material shows much less hysteresis between the charge and discharge branches compared to literature data for carbon nanotubes produced by CVD or laser ablation, indicating lower polarization or surface reaction barrier to insertion and removal of lithium. FIG. 7 shows the gravimetric charge capacity vs. cycle number at 20 mA/g and 60 mA/g current rates, showing excellent stability of the charge capacity over >20 cycles. Since this material can be packed to at least several times the density of previous carbon nanotube materials, the volumetric capacity is correspondingly greater.

A number of embodiments of the invention have been described. Nevertheless, it will be understood that various modifications may be made without departing from the spirit and scope of the invention. Accordingly, other embodiments are within the scope of the following claims.

What is claimed is:

1. A composition comprising a particle including a core and a shell, the core including a metal carbide and the shell including a carbon nanoparticle on at least a portion of a surface of the core.

2. The composition of claim 1, wherein the metal carbide is silicon carbide.

3. The composition of claim 1, wherein the carbon nanoparticle includes fullerenic carbon.

4. The composition of claim 1, wherein the shell covers at least 50% of a surface of the core.

5. The composition of claim 1, wherein the particle includes at least 2% by volume carbon nanoparticles.

6. The composition of claim 1, wherein the shell has an average thickness of at least 2.5 nanometers.

7. The composition of claim 1 wherein the particle has an average diameter of less than 100 micrometers.

8. The composition of claim 1, wherein the carbon nanoparticle includes a single-walled or multi-walled carbon nanotube or a nanofiber chemically attached to the core at at least one end.

9. The composition of claim 1, wherein the carbon nanoparticle includes a carbon nanotube or carbon nanofiber open at an end.

10. The composition of claim 1, further comprising a coating of metal or metal oxide on the carbon nanoparticle.

11. A composite abrasive particle comprising a core and a shell, the core including a metal carbide and the shell including a carbon nanoparticle on at least a portion of a surface of the core.

12. The composite abrasive particle of claim 11, further comprising a coating of metal or metal oxide on the carbon nanoparticle.

13. A grinding or finishing product comprising the particle of claim 1.

14. The product of claim 13, wherein the metal carbide is silicon carbide.

15. The product of claim 13, wherein the product is a grinding wheel, a cutting wheel, a coated abrasive or a suspension of abrasive particles in a liquid.

16. A structurally reinforced composite comprising the particle of claim 1.

17. The composite of claim 16, wherein the metal carbide is silicon carbide.

18. An electrochemical storage medium comprising the particle of claim 1.

19. A hydrogen storage medium comprising the particle of claim 1.

20. The storage medium of claim 18 or 19, wherein the metal carbide is silicon [symbol] de.

21. A composition comprising a particle including substantially densely- [symbol] rbon nanoparticles.

22. The composition of claim 21, wherein the carbon nanoparticles include fullerenic carbon.

23. The composition of claim 21, wherein the carbon nanoparticles include a single-walled or multi-walled carbon nanotube or a nanofiber.

24. The composition of claim 23, wherein at least one end of the nanotube or nanofiber is closed.

25. The composition of claim 23, wherein at least one end of the nanotube or nanofiber is open.

26. The composition of claim 21, further comprising a coating of metal or metal oxide on the carbon nanoparticles.

27. An abrasive particle comprising substantially densely-packed carbon nanoparticles.

28. The particle of claim 27, further comprising a coating of metal oxide or metal on the carbon nanoparticles.

29. A grinding or finishing product comprising the composition of claim 21.

30. The product of claim 29, wherein the product is a grinding wheel, cutting wheel, coated abrasive, or suspension of abrasive particles in a liquid.

31. A structurally reinforced composite comprising the composition of claim 21.

32. An electrochemical storage medium comprising the composition of claim 21.

33. A hydrogen storage medium comprising the composition of claim 21.

34. A method of manufacturing an article including a carbon nanoparticle on a surface of the article comprising:
heating an article including a metal carbide in a first atmosphere for a period of time to generate at least one carbon nanoparticle nucleus on the surface of the article, the first atmosphere being an oxidizing atmosphere relative to the metal carbide; and
heating the article including at least one carbon nanoparticle nucleus in a second atmosphere to grow the carbon nanoparticles on the surface of the article.

35. The method of claim 34, wherein the second atmosphere includes an inert gas.

36. A method of manufacturing an article including a carbon nanoparticle on a surface of the article comprising:
heating an article including a metal carbide in an oxygen-containing gas atmosphere at a temperature at which the metal carbide is in an active oxidation regime and carbon is in a graphite stability regime.

37. The method of claim 34 or 36, wherein the atmosphere includes CO or a mixture of CO and CO₂.

38. A method of manufacturing an article including a carbon nanoparticle on a surface of the article comprising heating an article including a metal carbide in an inert gas atmosphere at a temperature between 1000° C. and 2000° C.

39. The method of claim 38 wherein the inert gas includes a gas selected from the group of helium, hydrogen, argon, and a nitrogen-hydrogen mixture.

40. The method of claim 38, further comprising heating the article including the metal carbide to nucleate a carbon nanoparticle prior to heating the article including the metal carbide in an inert gas atmosphere at a temperature between 1000° C. and 2000° C.

41. The method of claim 34, 36, or 38, wherein the carbon nanoparticle includes fullerenic carbon.

42. The method of claim 34, 36, or 38, wherein the metal carbide is silicon carbide.

43. The method of claim 34, 36, or 38, wherein the pressure is greater than 10⁻³ Torr.

44. The method of claim 34, 36, or 38, wherein the pressure is greater than 10⁻² Torr.

45. The method of claim 34, 36, or 38, wherein the temperature is between 1200° C. and 2000° C.

46. A method of forming a composite comprising:
dispersing carbon nanoparticles in a matrix including an oxide of a first metal; and
contacting the matrix with a reducing agent to reduce the oxide of the first metal.

47. The method of claim 46, wherein the reducing agent is a second metal.

48. The method of claim 46, wherein the first metal is copper, iron, lead, nickel, cobalt, tin, zinc, sodium, chromium, manganese, tantalum, vanadium, or boron.

49. The method of claim 47, wherein the second metal is silicon, titanium, aluminum, cerium, lithium, magnesium, calcium, lanthanum, beryllium, uranium, or thorium.
